(19) United States
(12) Patent Application Publication
(10) Pub. No.: US 2008/0089093 A1
(43) Pub. Date: Apr. 17, 2008

(54) BACKLIGHT UNIT USING PARTICULAR DIRECT BACKLIGHT ASSEMBLY

(76) Inventors: Anne M. Miller, Batavia, NY (US); Ronald J. Sudol, Rochester, NY (US); Junwon Lee, Webster, NY (US); Erica N. Montbach, Richfield, OH (US)

Correspondence Address: Andrew J. Anderson;Patent Legal Staff, Eastman Kodak Company, 343 State Street, Rochester, NY, 14650-2201, US

(21) Appl. No.: 11/549,987

(22) Filed: Oct. 17, 2006

(51) Int. Cl. F21V 7/04

(52) U.S. Cl. 362/613

(57) ABSTRACT

An illumination device comprising in order from bottom to top (a) a solid transparent light transmission plate having a bottom and top surface, and (b) a light extraction unit having a light entry and a light extraction surface separated from the transmission plate by one or more optical interfaces, said light transmission plate comprising at least one cavity/light source unit comprising a cavity containing a light source and air or other material of refractive index less than the light transmission plate, wherein the light plate includes a surface for restricting the angle at which at least some of the light from the light source leaves the cavity, wherein the light extraction unit includes (1) a light polarizer (2) a light-scatterer, or (3) a light redirector.

### FIELD OF THE INVENTION

The present invention generally relates to a display backlight illumination assembly for producing both non-polarized and nominally polarized light and more particularly relates to an assembly that is direct lit rather than edge lit.

### BACKGROUND OF THE INVENTION

As the performance and cost of liquid crystal displays (LCDs) improve, LCDs are becoming the primary display choice in applications ranging from cell phones to large screen televisions. Since liquid crystals are not self-luminous, they require a backlight assembly for illumination. Such backlights are commonly located directly beneath an LC panel assembly, wherein the LC panel assembly serves to modulate the light emitted by the backlight, creating the image observed by the end-user. To create a visually appealing display, the backlight is required to provide a planar source of light that has a uniform spatial brightness. Further, it is desired that the backlight assembly provide this uniform spatial light distribution in an efficient manner, so that display energy requirements and heat generation may be minimized.

For transmissive LCDs, there are generally two types of backlights, edge-lit and direct-lit. The edge-lit type typically comprises a lightguide, a light source partially surrounded by a reflector and positioned adjacent to at least one edge of the lightguide, and a combination of optical structures such as scattering dots, scattering particles and reflecting and refracting surfaces that couple light out of the guide and redirect it into preferred directions towards the LC panel.

Unlike edge-lit backlights that have one or more light sources located around the side edges of the backlight, direct-lit backlights have their one or more light sources located directly under the backlight. Direct-lit backlights replace the lightguide plates found in edge-lit backlights with one or more light diffusing plates and films that direct light into the desired view angle. Further, these plates and films scatter the light so to produce a sufficiently uniform distribution of light emitted towards the LC panel. Replacement of the lightguide plate by the diffuser plates and additional layers typically produces direct-lit displays that are thicker than edge-lit units. The thinness of edge-lit backlights is enabled, in part, through the use of lightguide plates. Lightguide plates guide light from the one or more light sources located along the lightguide edges, and emit the light via scattering or light emitting features. Lightguides conduct light through total internal reflection, and emit light via scattering, refraction, or both. Such multiple reflections and scattering events mean that much of the light emitted towards the LC panel travels a distance at least several times greater than the physical thickness of the edge-lit backlight. These longer propagation distances allow light to mix and uniformize. In contrast, direct-lit backlights do not typically include lightguides. Light propagation and mixing typically do not occur in a horizontal direction, but in the thickness direction of the LC panel. This means that a thicker display is typically required in direct-lit constructions so to achieve an acceptable degree of spatial uniformity of brightness.

Light emitted by the edge-lit and direct-lit backlights is typically randomly polarized. When this randomly polarized light is incident upon the bottom polarizer of a typical LC panel, approximately half of the light is lost through absorption. This loss due to absorption can be reduced significantly by polarizing the light prior to its impinging the bottom polarizer of the LC panel. This can be done today through the use of a reflective polarizer, inserted between the LC panel and the backlight. Examples of such reflective polarizers are described in U.S. Pat. No. 6,590,707 B1 and WO2000065385 A1 and comprise additional components that are added to an LC display in order to increase the overall energy efficiency.

One way to overcome the inherent disadvantages of typical direct-lit backlight is by redirecting the light from each of the one or more sources in such a manner that it appears to be coming from the edge of the backlight, and launching this light into a lightguide disposed between the light sources and LC panel. WO2004/027466A1, U.S. Pat. No. 7,068,910 and WO2004/027467A1 present a direct-lit backlight design wherein light redirection is accomplished by an additional structure inserted between the light sources and the lightguide. Further, a diffuse reflector is inserted around the one or more light sources, so to recycle the polarization reflected in the TIR interaction. This configuration is disadvantaged relative to more common edge-lit backlight constructions in that it adds substantially to the overall thickness of the display. Additionally, the nature of the diffuse reflector does not lend itself to either improved efficiency or uniformity.

U.S. Pat. No. 6,808,279 (Greiner) discloses a lighting device with an optical waveguide that has a light emission surface and a plurality of channels each with a least one substantially linear light source.

While these known approaches generally provide illumination schemes for direct-lit liquid crystal display application they have certain shortcomings. The former solution while addressing uniformity makes less efficient use of the light and tends to be less compact. The latter approach does address both uniformity and compactness; however light extraction and redirection are overlooked. Thus, there remains a need in the field of backlights in direct-lit LC displays, for backlighting systems that are capable of achieving high spatial uniformity of brightness and compact thickness. In addition, there is a need for such backlights to overcome the absorptive losses that are common when randomly polarized light impinges the bottom polarizer of a typical LC panel.

### SUMMARY OF THE INVENTION

The invention provides an illumination device comprising in order from bottom to top (a) a solid transparent light transmission plate having a bottom top surface, and (b) a light extraction unit having a light entry and a light extraction surface separated from the transmission plate by one or more optical interfaces, said light transmission plate comprising at least one cavity/light source unit comprising a cavity containing a light source and air or other material of refractive index less than the light transmission plate, wherein the light plate includes a surface for restricting the angle at which at least some of the light from the light source leaves the cavity, wherein the light extraction unit includes (1) a light polarizer (2) a light-scatterer, or (3) a light redirector.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is an exploded schematic cross-sectional view of a traditional direct-lit backlight.

FIG. 2 is a schematic cross-sectional view of a first embodiment of the backlight unit using a backlight assembly according to the present invention.

FIG. 3 is a schematic cross-sectional view of a second embodiment of the backlight unit using smaller bottom reflector according to the present invention.

FIG. 4 is a schematic cross-sectional view of a third embodiment of the backlight unit using trapezoidal cavity for light source according to the present invention.

FIG. 5 is a schematic cross-sectional view of a fourth embodiment of the backlight unit having light source wrapped around by reflectors according to the present invention.

FIG. 6 is a schematic cross-sectional view of a fifth embodiment of the backlight unit that light source reflector is skewed according to the present invention.

FIG. 7 is a schematic cross-sectional view of a first embodiment of a light extraction layer with microstructures comprises a micro structured anisotropic layer and an isotropic layer.

FIG. 8 is a schematic cross-sectional view of a second embodiment of the light extraction layer with microstructures comprises a micro structured anisotropic layer and an isotropic layer.

FIG. 9 is a schematic cross-sectional view of a third embodiment of a light extraction layer comprising of a scattering layer.

FIG. 10 is a schematic cross-sectional view of a fourth embodiment of a light extraction layer comprising of a plurality of light extraction features distributed along optical interface.

### DETAILED DESCRIPTION OF THE INVENTION

The invention is summarized above.

The invention disclosed herein can reduce the overall thickness of a direct-lit backlight assembly while producing a sufficiently uniform spatial distribution of light that is directed to the LC panel of the display. In addition, light emitted from the backlight assembly may be preferentially polarized so to reduce the overall light absorption by the bottom polarizer of the LC panel assembly.

The present applications thus describe display backlight illumination assemblies for producing non-polarized and nominally polarized light and more particularly relates to assemblies that are direct lit.

The following definitions apply to the description herein:

Optic axis refers to the direction in which propagating light does not see birefringence.

Light transmission plate refers to the solid transparent plate in which light enters at angles that induce total internal reflection.

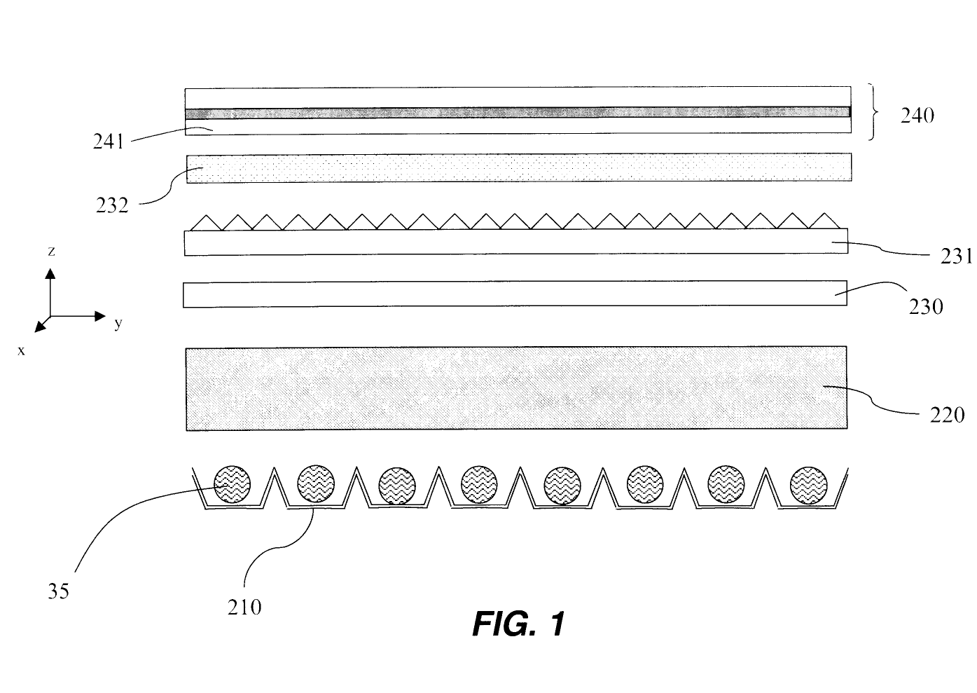

FIG. 1 illustrates the structure and components of a traditional direct-lit backlight such as those presently used in LCD televisions. The traditional backlight includes an array of light sources 35, typically cold cathode fluorescent lamps and a shaped reflector 210 located behind the array of light sources 35 for directing light towards the viewer. A thick diffuser plate 220 is usually placed over the array of light sources 35 to diffuse light from the individual sources. One or more additional diffuser films or plates 230 are located above the thick diffuser plate 220 to enhance the spatial uniformity of the backlight brightness as well as to increase the overall on-axis gain by directing light preferentially in the forward direction, towards the viewer. One of the diffuser films or plates 230 can be replaced by one or more enhancement films 231 having light redirecting features that refract light into a reduced cone angle towards the viewer. Light outside this cone angle is “recycled”, reflected back into the backlight where it propagates until it is reflected or scattered through the backlight system, towards the viewer. This traditional backlight can include a reflective polarizer film 232 located between the one or more backlight diffusers or plates 230 and enhancement films 231 and the LC panel 240. The reflective polarizer film 232 causes one polarization state to be transmitted towards the LC panel 240, with the orthogonal state reflected and “recycled” in the backlight. The polarization state transmitted towards the LC panel 240 is preferentially aligned with the pass axis of the bottom polarizer 241 of the LC panel 240. The recycled orthogonal polarization state is scattered or reflected in the backlight so to regenerate some amount of light in the one desired polarization state; this amount of light in the one desired polarization state is transmitted by the backlight assembly towards the LC panel 240. The process is repeated with the reflected light in the backlight, with additional amounts of the one desired polarization state emitted towards the LC panel. The use of the reflective polarizer film 232 is the enhanced efficiency of light utilization in the LC display, and the reduction of the amount of light absorbed by the bottom polarizer 241 of the LC panel 240. An example is given in US2005/0135117 for direct-lit backlights.

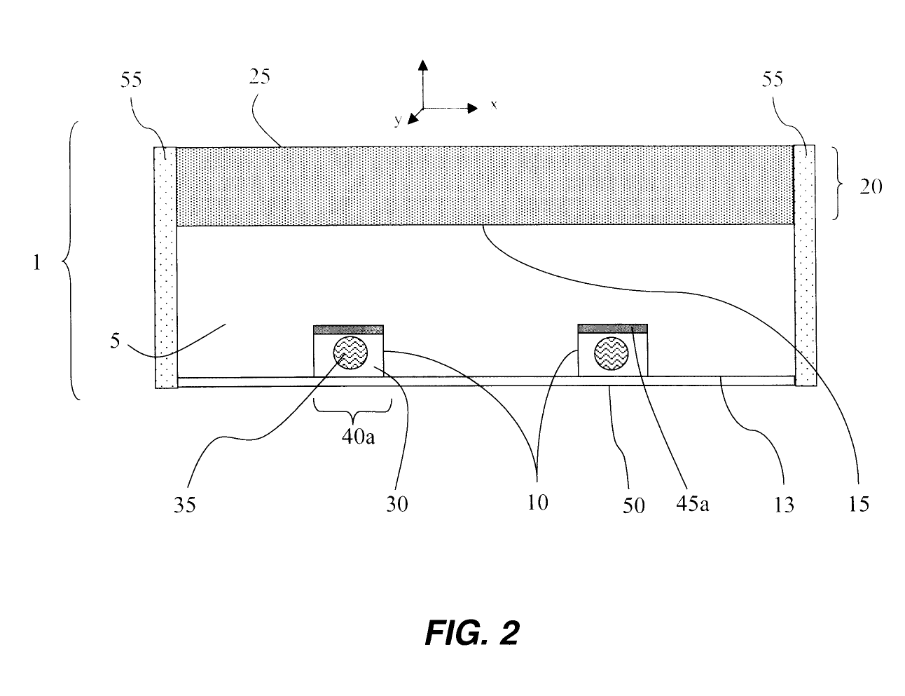

FIG. 2 shows a first embodiment of the backlight unit using a backlight assembly according to the present invention. The illumination device 1 comprises a light transmission plate 5, a back reflector 50 located on the bottom surface 13 of the light transmission plate 5 and an unspecified light extraction unit 20 which forms an optical interface 15 with the light transmission plate 5 and has a light extraction surface 25. Within the light transmission plate 5 there are a multiplicity of cavity/light source units 40a each of which are comprised of a light source 35, a front reflector/absorber 45a, light input surface 10 and an air filled cavity 30. In addition the illumination device 1 has substantially parallel end reflectors 55 which may be diffuse or reflective.

The thickness of the light transmission plate is adjusted to the amount of light and uniformity required for a particular application as well as the number and sizes of the sources to meet the requirements. Conveniently the thickness can range between 1 mm and 50 mm. More appropriate would be thicknesses in the range 2 mm to 20 mm. Good performance has been found in the neighborhood of 5 mm to 15 mm thickness.

The illumination device 1 according to the present invention operates as follows. Cavity/light source units 40a located within the light transmission plate 5 in combination with the front reflector/absorber 45a and the back reflector 50 direct the light emitted from light source 35 to light input surfaces 10 whereby it enters the light transmission plate 5 in a range of angles which eventually impinge upon the optical interface 15 at angles equal to or greater than the angle for total internal reflection for an air interface. The unspecified light extraction unit 20 located at this interface redirects this light, causing it to exit the illumination device 1 through the light extraction surface 25. In addition spacing, size and distribution of the cavity/light source units 40a can be varied to better control the spatial uniformity of the light leaving the light extraction surface 25. Typically the light entering the lightguide ranges from approximately plus or minus 36 degrees to plus or minus 45 degrees from the light input surface 10 normal. Preferably light enters the lightguide plate within approximately plus or minus 38 to 43 degrees of the light input surface 10 normal.

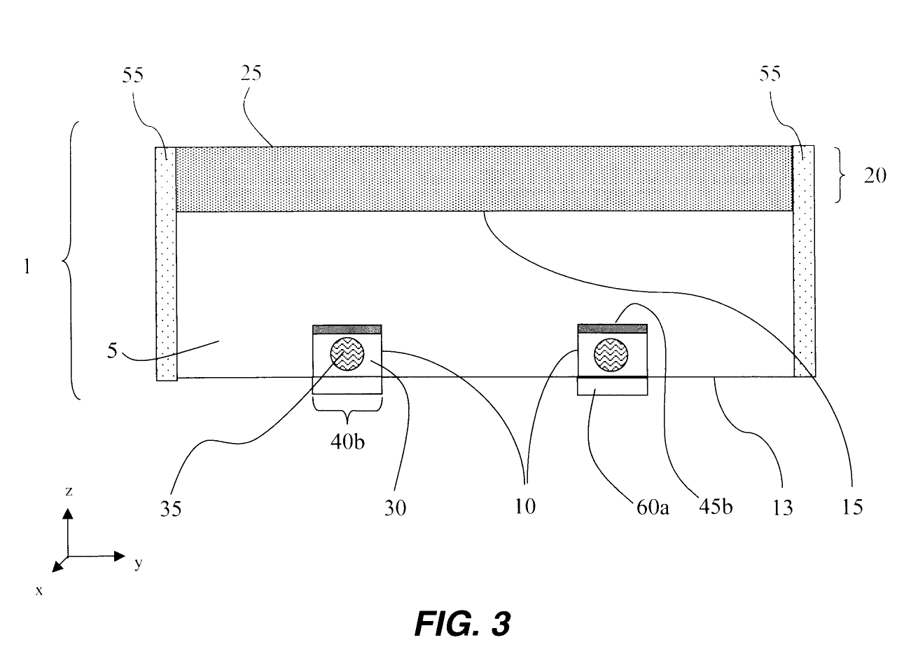

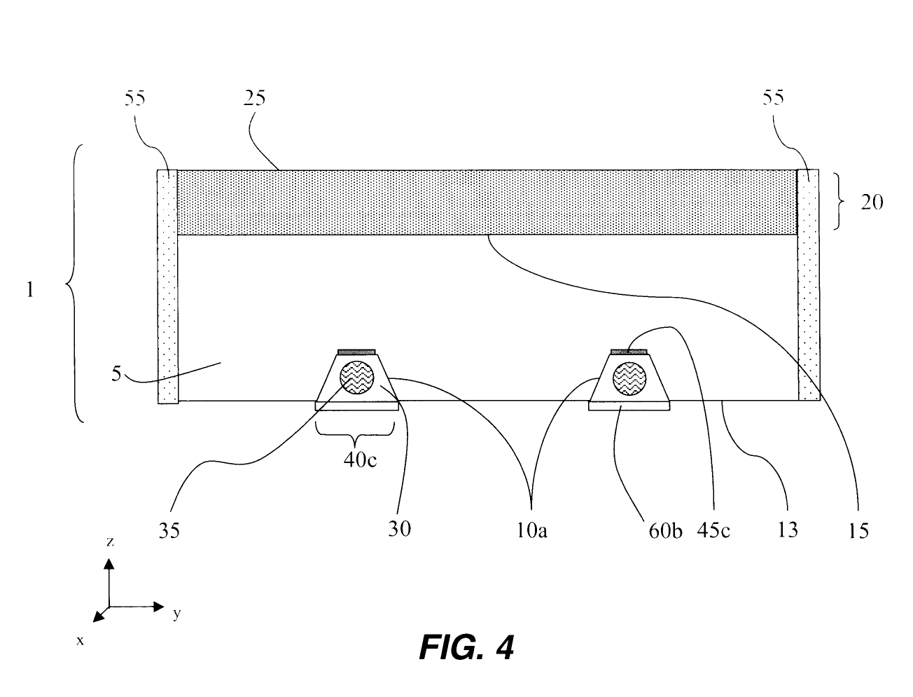

In another embodiment, illustrated in FIG. 3, the cavity/light source units 40b again consists of a front reflector/absorber 45b, an air filled cavity 30 and light input surfaces 10. However, in contrast to the first embodiment, the back reflector is replaced with individual rear reflectors 60a. This can be done to reduce the backlight unit manufacturing cost. In a third embodiment, illustrated in FIG. 4, the cavity/light source units 40c with front reflectors/absorber 45c are configured to have slanted light input surfaces 10a. It is the purpose of the slanted input surfaces 10a to redirect the range of angles entering the light transmission plate 5 toward a direction, which is consistent with both the acceptance and redirection properties of the unspecified light extraction unit 20.

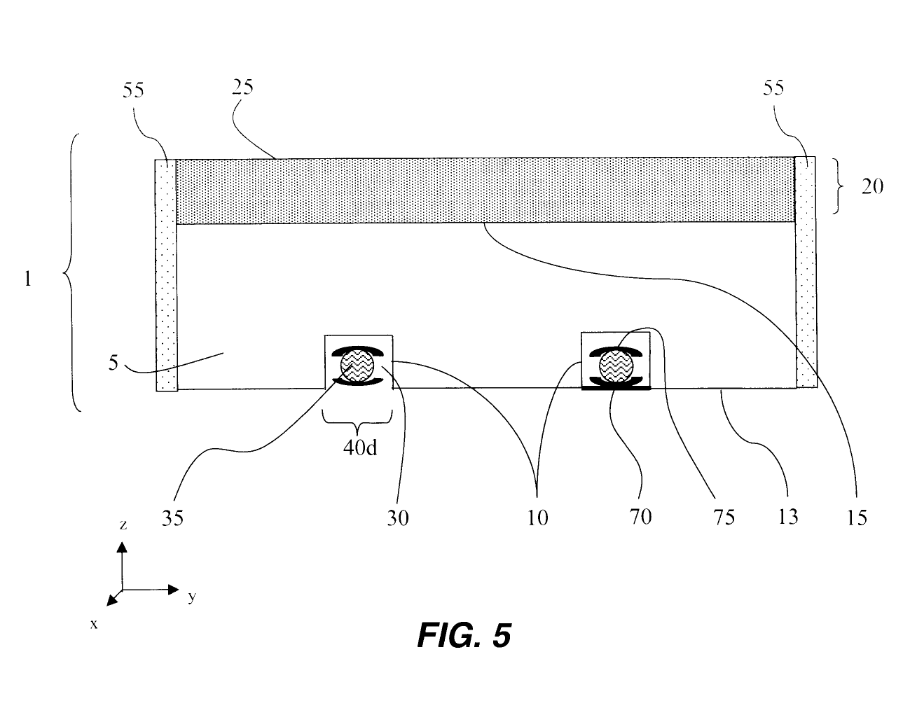

Another embodiment is illustrated in FIG. 5. In this case, the cavity/light source units 40d consist of light sources 35 that have integrated front reflectors 75 and rear reflectors 70. These light sources 35 are located within air filled cavities 30. Again light enters the light transmission plate 5 through light input surfaces 10. This is a way of simplifying the backlight unit manufacturing process.

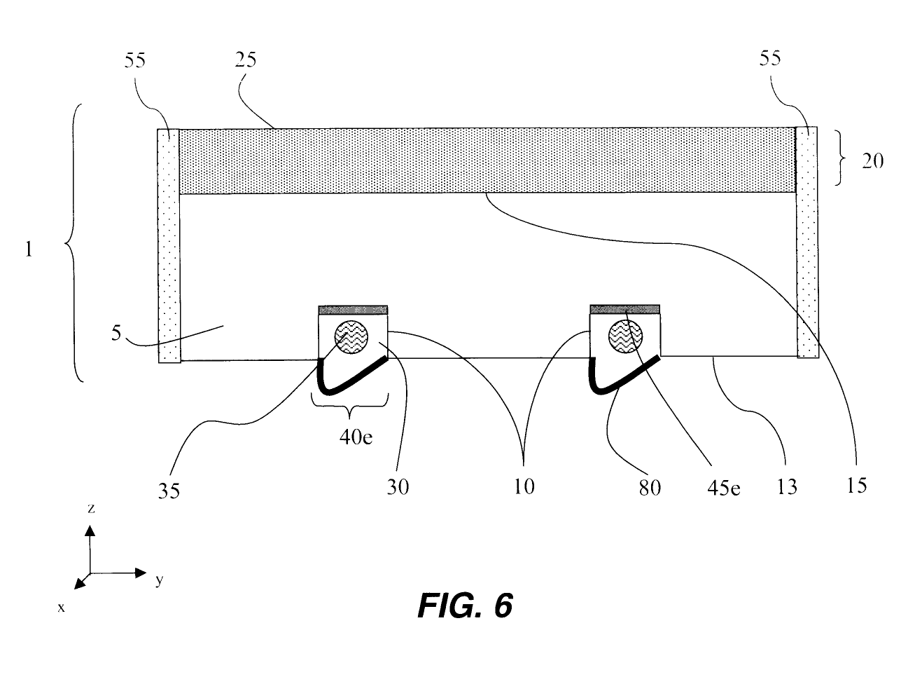

In a fifth embodiment, illustrated in FIG. 6, the cavity/light source units 40e are configured with curved rear reflectors 80. The curved rear reflector 80 provides additional control over both the direction and angular range of light entering the light transmission plate 5 through the light input surfaces 10. This shaping and redirection of the light distribution when combined with the properties of the unspecified light extracting unit 20 will determine the distribution and direction of the light leaving the light extraction surface 25.

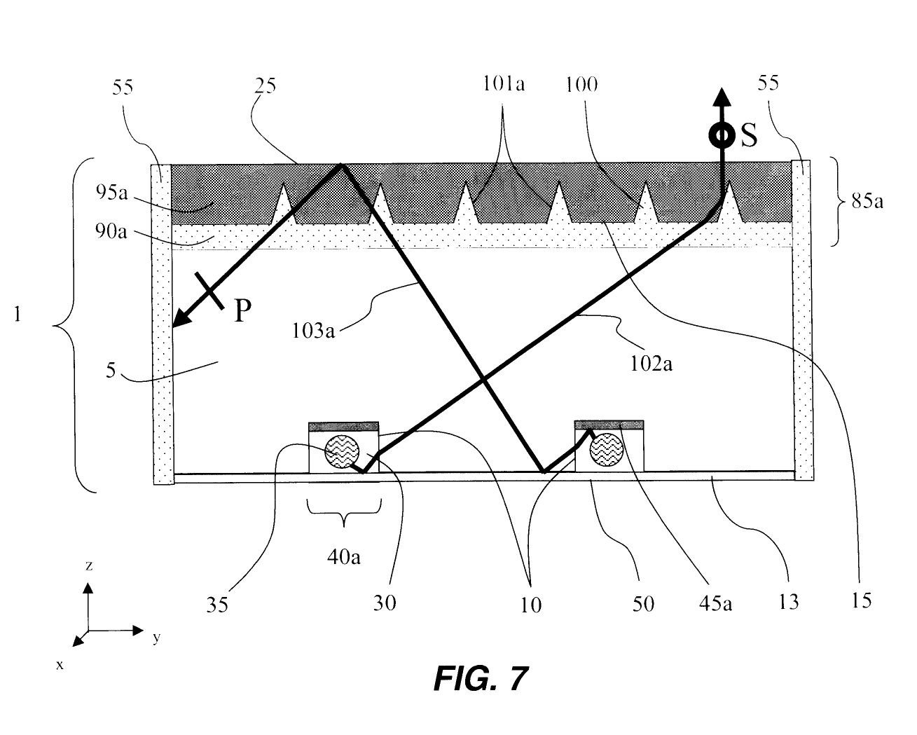

FIG. 7 shows another embodiment of the direct-lit backlight according to the present invention. Therein the light extraction unit with microstructures 85a comprises a micro structured anisotropic layer 95a and an isotropic layer 90a. The optical interface 15 is formed between the isotropic layer 90a and the anisotropic layer 95a. In this embodiment, light of a particular polarization, e.g. s-polarized light is selectively redirected within the light extraction layer with microstructures 85a for passage through the light extraction surface 25. The other polarization, e.g. p-polarization, is totally internally reflected within the light extraction layer with microstructures 85a and returned to the light transmission plate 5 for recycling. This behavior is illustrated for the s-polarization by ray 102a and for the p-polarization by ray 103a. For this embodiment, light transmission plate 5 and the isotropic layer 90a have nearly equal refractive indices for both polarizations, which is less than the extraordinary index of anisotropic layer 95a and nearly equal to its ordinary index. The optical axis of the anisotropic layer 95a is oriented perpendicular to the plane of the FIG. 7 which is along the x-axis. Consequently upon entering the light transmission plate 5 after passage through the light input surface 10, ray 102a enters the anisotropic layer 95a encountering microstructures 100 at microstructure interfaces 101a. There the s-polarized light ray 102a is totally internally reflected and is directed toward light extraction surface 25 where it exits the illumination device 1. Conversely upon entering light transmission plate 5, the p-polarized light of ray 103a encounters nearly equal refractive indices along its path to the light extraction surface 25 where it will be totally internally reflected and thereby returned toward the light transmission plate 5 for recycling. Additionally the microstructures 100 can be varied in position and shape or their number per unit area can be adjusted to further improve the uniformity of the light output.

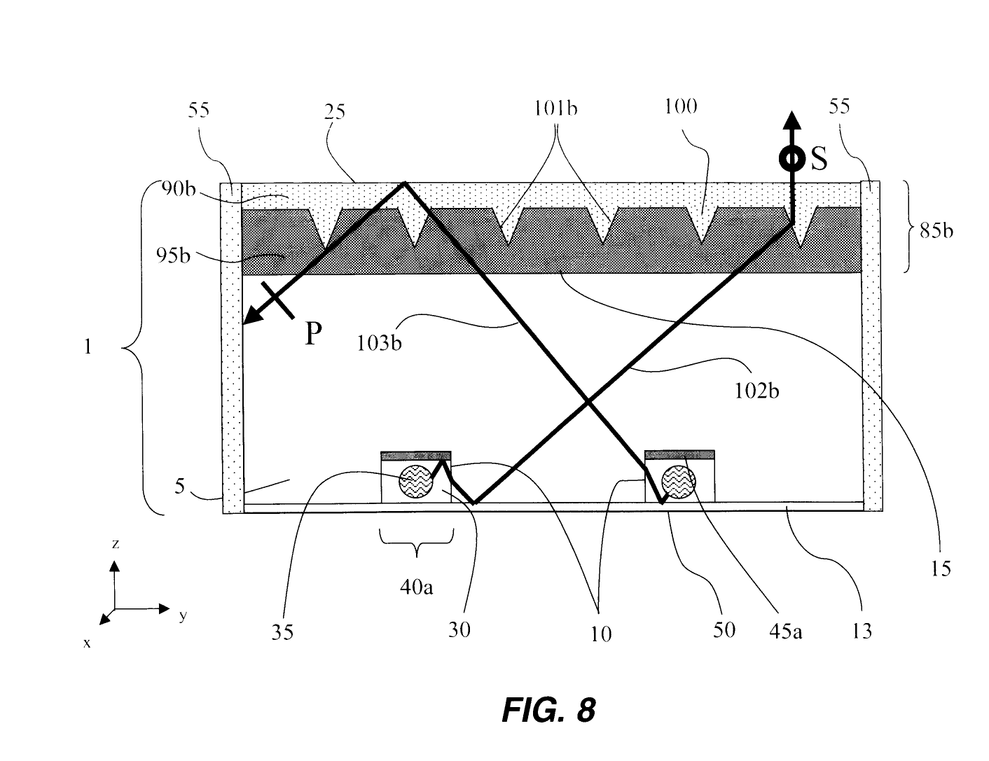

Another embodiment of the illumination unit according to the present invention is shown in FIG. 8. Here again the light extraction layer with microstructures 85b comprises a micro structured anisotropic layer 95b and an isotropic layer 90b. However in this embodiment, light passing through optical interface 15 first encounters the anisotropic layer 95b before passing through isotropic layer 90b. As illustrated by s-polarized light ray 102b, light interaction with the microstructures 100 at the microstructure interface 101b causes refraction of the s-polarization toward the light extraction surface 25. The p-polarized light ray 103b, again passes through material having essentially the same refractive indices and is totally internally reflected at the light extraction surface 25.

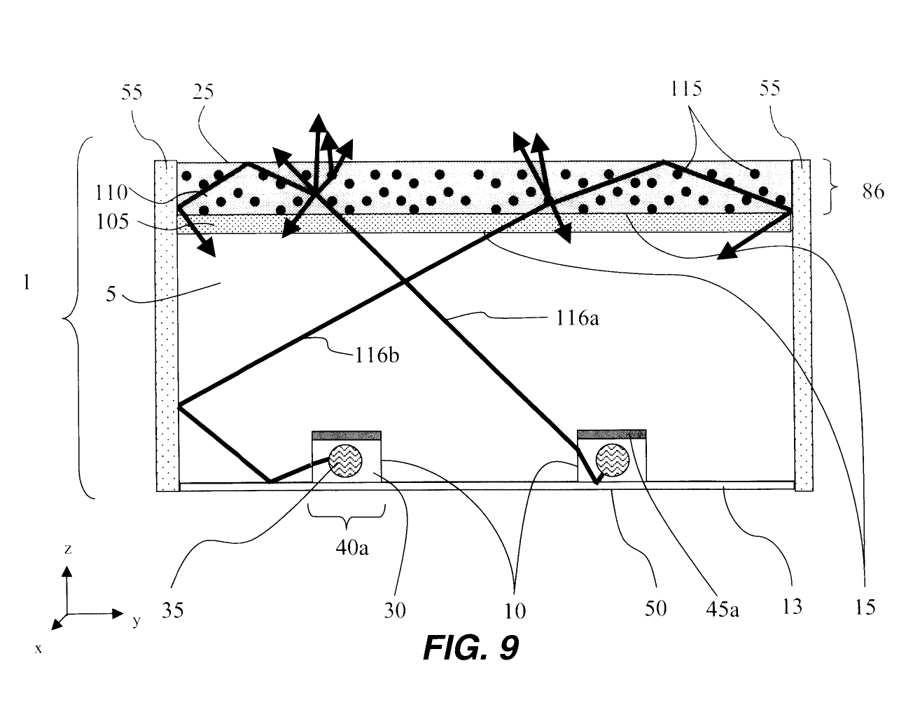

Another embodiment shown in FIG. 9, a light extraction unit with light scattering material 86 rather than the micro structured anisotropic layers shown in FIGS. 7 and 8 accomplishes light extraction. The light extraction unit with light scattering material 86 comprises a continuous polymeric material 110 a scattering material or voids 115. The refractive indices of the continuous polymeric material 110 substantially matches the refractive indices of both the isotropic pressure sensitive adhesive (PSA) 105 and the light transmission plate 5. However there is a mismatch between the indices of the polymeric layer 110 and the scattering material or void 115. As a result light incident on light extraction unit with light scattering material 86 that further impinges the scattering material or voids 115, such as light rays 116a and 116b will be redirected with some of the scattered light reaching the light extraction layer 25 where it will exit the illumination unit 1. Light that reaches the light extraction surface 25 at angles smaller than the angle for total internal reflection will be transmitted by the illumination. Light that reaches the extraction surface 25 at angles greater than the angle for total internal reflection will be returned toward the light transmission plate 5 for recycling.

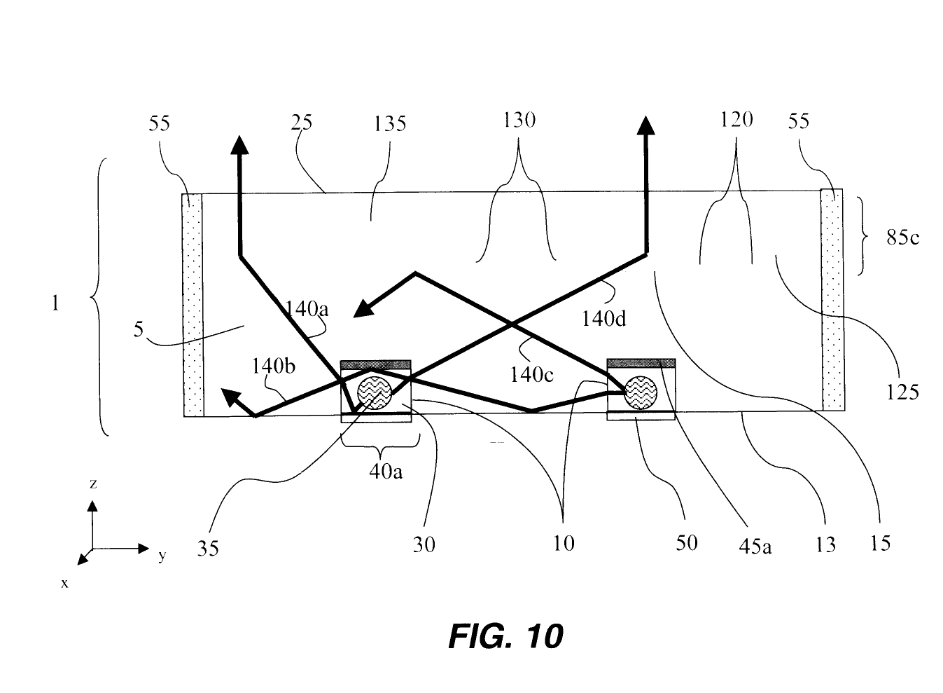

FIG. 10 shows yet another embodiment of the illumination unit according to the present invention. The light extraction unit with microstructures 85c consists of a plurality of light extraction features 125 distributed along optical interface 15. Each of the features has a refractive index that is substantially equal to that of the light transmission plate 5. Voids 120 between features have a lower refractive index than that of the light transmission plate 5. Consequently a light rays 140a and 140d, entering light transmission plate 5 through light input surface 10 and is incident upon the light extraction feature 125 will be reflected by void surface 130 toward light extraction surface 25 as a result of total internal reflection. Conversely, light ray 140c entering light transmission plate 5 is incident upon optical interface 15 between light extraction features 125. There the light ray 140c is totally internally reflected as a result of the lower index void 120 regions and sent back to the light transmission plate 5 for another chance to be extracted via light extracting feature 125 without any light loss. Light ray 140b passes through light transmission plate 5 and the cavity/light source unit 40a in the direction of the end reflectors 55. Light reflected from the end reflectors 55 will be redirected back into the light transmission plate 5 for light extraction.

### EXAMPLES

### Comparative Example of Traditional Direct-Lit Backlight

As previously discussed, a traditional direct-lit backlight includes an array of light sources 35, a shaped reflector 210 located behind the light sources with a thick diffuser plate 220 placed over the array but at a distance to improve the spatial uniformity of the backlight brightness. Any additional diffusing films that are added for uniformity improvement capability or hiding power are generally much thinner than the typical thick diffuser plate 220, which has a thickness on the order of two millimeters. As such, for comparative purposes the thickness of the traditional direct-lit backlight is considered as the distance from the reflector surrounding the light source array 35 to the top of the thick plate diffuser. With this as a basis a sampling of traditional systems indicates that thicknesses can range from 19 to 24 millimeters.

For the system presented in WO2004027466 and U.S. Pat. No. 7,068,910, this backlight thickness is the distance from the diffuse reflector to the light output unit. The embodiments contained herein can used to arrive at an estimate of this backlight thickness. The lightguide plate, which acts as a light buffer typically, has a thickness on the order of 11 millimeters. In this system design, the light sources are located external to the lightguide plate, which adds to the overall thickness. Adding the diffuse reflector results in a backlight thickness on the order of at least 16 millimeters. Consequently this backlight configuration has a thickness within the range similar to that of the traditional system if not larger.

### EXAMPLE

### One Implementation of Inventive Backlight

For the polarizing backlight unit FIG. 7 described herein the thickness is considered as the distance from the back reflector 50 to the light extraction surface 25, respectively, as the inventive systems do not require a thick plate diffusing plate. It has been found through simulations that embodiments described herein that employ cavities within the light transmission plate 5 to contain one or more light sources 35 can have a backlight thicknesses on the order of 11 millimeters, significantly smaller than the thickness of the comparative traditional backlights.

The invention has been described in detail with particular reference to certain preferred embodiments thereof, but it will be understood that variations and modifications can be effected within the spirit and scope of the invention. The patents and other publications referred to herein are incorporated by reference.

### Parts List

1—Illumination device
5—Light transmission plate
10—Light input surface
10a—Slanted light input surfaces
13—Bottom surface
15—Optical interface
20—Unspecified light extraction unit
25—Light extraction surface
30—Air filled cavity
35—Light source
40a, 40b, 40c, 40d, 40e—Cavity/light source unit
45a, 45b, 45c, 45e—Front reflector/absorber
50—Back reflector/absorber
55—End reflector
60a, 60b—Rear reflector
70—Rear light reflector
75—Front light reflector
80—Curved rear reflector
85a, 85b, 85c—Light extraction unit with microstructures
86—Light extraction unit with scattering material
90a, 90b—Isotropic layer
95a, 95b—Anisotropic layer
100—Microstructures
101a, 101b—Microstructure interface
102a, 102b—S-polarized light ray
103a, 103b—P-polarized light ray
105—Isotropic pressure sensitive adhesive (PSA)
110—Polymeric layer
115—Scattering material or voids
116a, 116b—Light ray
120—Voids
125—Light extraction feature
130—Void surface
135—Substrate
140a, 140b, 140c, 149d—Light ray
210—Shaped reflector
220—Thick diffuser plate
230—Diffuser film or plate
231—Enhancement film
232—Reflective polarizer film
240—LC panel
241—Bottom polarizer

1. An illumination device comprising in order from bottom to top (a) a solid transparent light transmission plate having a bottom and top surface, and (b) a light extraction unit having a light entry and a light extraction surface separated from the transmission plate by one or more optical interfaces, said light transmission plate comprising at least one cavity/light source unit comprising a cavity containing a light source and air or other material of refractive index less than the light transmission plate, wherein the light plate includes a surface for restricting the angle at which at least some of the light from the light source leaves the cavity, wherein the light extraction unit includes (1) a light polarizer (2) a light-scatterer, or (3) a light redirector.

2. The device of claim 1 wherein the light extraction unit comprises an anisotropic layer and an isotropic layer wherein the interface between the anisotropic layer and the isotropic layer comprises microstructures whereby the light extraction unit preferentially transmits one polarization.

3. The device of claim 1 wherein the light extraction unit comprises light scattering particles or voids in a polymeric material.

4. The device of claim 1 wherein the light extraction unit comprises a material of refractive index substantially matched to the light transmission plate and comprises a plurality of light extraction features that protrude downwardly at the bottom of the light extraction unit and are optically coupled to the light transmission plate.

5. The device of claim 1 wherein the light transmission plate comprises at least three cavity/light source units.

6. The device of claim 1 wherein the cavities are linear and elongated in a horizontal plane.

7. The device of claim 1 wherein the cavities are non-linear.

8. The device of claim 1 wherein the light source is a cold cathode fluorescent lamp, or a light emitting diode.

9. The device of claim 1 wherein the cavity comprises a front reflector and a bottom reflector on the bottom surface of the light transmission plate

10. The device of claim 1 wherein the cavity comprises a front surface and a rear surface which are reflective.

11. The device of claim 1 wherein the cavity has a front surface and a rear surface which are light absorptive.

12. The device of claim 1 wherein the cross-section shape of the light input surfaces of the cavities to the transmission plate is substantially rectangular.

13. The device of claim 1 wherein the cross-section shape of the light input surfaces of the cavities to the light transmission plate is selected from the group consisting of circular, rectilinear, elliptical, triangular, trilobal, trapezoidal, and non symmetrical.

14. The device of claim 1 wherein the light source comprises at least one reflective surface or one light absorptive surface.

15. The device of claim 1 wherein both the light source and the cavity comprise at least one reflective surface or one light absorptive surface.

16. The device of claim 1 wherein the cross-section shapes of the light input surfaces of the cavities are substantially rectangular and have a substantially flat front surface and a rear surface wherein the rear surface is curved.

17. The device of claim 1 wherein the light transmission plate comprises end reflectors.

18. The device of claim 1 wherein the bottom of the light transmission plate is reflective.

19. The device of claim 1 wherein at least 88% of the light enters the light plate at an angle plus or minus 39 degrees to the normal to the light input surface.

20. The device of claim 2 comprising light extraction features with surfaces that are curved

21. The device of claim 2 comprising light extraction features with surfaces that are faceted.

22. The device of claim 4 wherein the anisotropic layer is closest to the light transmission plate.

23. The device of claim 4 wherein the isotropic layer is closest to the light transmission plate.

24. The device of claim 4 wherein the cavity/light source units run the length of the light transmission plate parallel to the microstructures.

25. The device of claim 1 comprising light sources located at least partially within cavities that extend into the lightguide plate wherein the cavities have one or more reflective surfaces around the light source that cause the light to be emitted in a side-ways fashion directing the light towards the light extraction unit.

26. The illumination device of claim 1 wherein the illumination device comprises a display that has at least a 43 cm diagonal.

27. A LC display device comprising an illumination device comprising in order from bottom to top (a) a solid transparent light transmission plate having a bottom and top surface, and (b) a light extraction unit having a light entry and a light extraction surface separated from the transmission plate by one or more optical interfaces, said light transmission plate comprising at least one cavity/light source unit comprising a cavity containing a light source and air or other material of refractive index less than the light transmission plate, wherein the light plate includes a surface for restricting the angle at which at least some of the light from the light source leaves the cavity, wherein the light extraction unit includes (1) a light polarizer (2) a light-scatterer, or (3) a light redirector.

28. A LC display device of claim 27 further comprising above the illumination device:
one or more diffuser films or plates;
a reflective polarizer; and
a polarizer;

29. A display device comprising An illumination device comprising in order from bottom to top (a) a solid transparent light transmission plate having a bottom and top surface, and (b) a light extraction unit having a light entry and a light extraction surface separated from the transmission plate by one or more optical interfaces, said light transmission plate comprising at least one cavity/light source unit comprising a cavity containing a light source and air or other material of refractive index less than the light transmission plate, wherein the light plate includes a surface for restricting the angle at which at least some of the light from the light source leaves the cavity, wherein the light extraction unit includes (1) a light polarizer (2) a light-scatterer, or (3) a light redirector.

30. A display device of claim 29 further comprising a transparent image film located on or above said light emitting surface of said illumination device.
